(19) United States
(12) Patent Application Publication
(10) Pub. No.: US 2024/0300685 A1
(43) Pub. Date: Sep. 12, 2024

(54) LOADER SYSTEM FOR LOADING PRODUCT INTO PACKAGING BOXES

(71) Applicant: PROSEAL UK LIMITED, Adlington (GB)

(72) Inventors: Nicholas R. Severn, Northwich (GB); Jacob E. Joyce, Macclesfield (GB); Edward J. Holmes, Rainow (GB)

(73) Assignee: PROSEAL UK LIMITED, Adlington (GB)

(21) Appl. No.: 18/181,734

(22) Filed: Mar. 10, 2023

(51) Int. Cl. B65B 35/38; B65G 47/34

(52) U.S. Cl. CPC B65B 35/38; B65G 47/34

(57) ABSTRACT

A loader system (20) lifts/removes articles 22 from a supply conveyor (24) for placement into containers (26) disposed on a takeaway conveyor (28). The containers (26) may have a flap (30) that extends across the open top of the containers. The loader system (20) includes a 2D actuator (32) for loading the articles (22) received on the supply conveyor (24) into to containers (26). When the actuator (32) approaches the containers (26), the auxiliary linkage arrangement 100, operating independently of the actuator, tilts the articles (22) downwardly so as to pass beneath the flap (30), and then rotates the articles into horizontal orientation to set within the containers. A control system (40) controls the operation of the conveyors (24) and (28), as well as the loader system (20), to transfer the articles (22) from the conveyor (24) and into the containers (26).

### BACKGROUND

In the distribution process of foods and other types of goods, it is typically necessary to consolidate individual articles or packages containing the food or other types of goods into larger groupings, for instance, in containers, boxes, cartons, or trays (collectively “containers”). It is desirable to carry out this operation using automated equipment. However, often this is not possible due to containers having a lip or reinforcing ledge extending across the ends of the open top of the containers, so that articles or packages must slide beneath the lip or ledge for placement into the containers. Or the container may have flaps used to close the containers once filled, and one or more of the flaps overlie the top of the container, thereby restricting access to the container. As such, automated equipment that is limited to raising and lowering the articles or packages in a vertical direction is not capable of avoiding the lip, ledge, or flap of the container. As such, it is necessary to manually fill the containers, wherein the articles or packages arrive at a packing station on conveyor, and then workers manually place the articles or packages into the containers.

The present disclosure seeks to provide equipment or the automated packing of articles or packages into a container having an obstruction to opening of the container, and in particular if the distance between the bottom of the container and the obstruction is less than the height dimension of the article or package being loaded into the container. Further, the present disclosure is applicable not only for food distribution, but also for distribution of many other types of goods that are consolidated for shipping or distribution.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a loader system is provided for transferring articles from a receiving location into containers that may have an obstruction extend at least a part of the opening of the container (closing a portion of the container open top). The loader system comprises a two axis actuator comprising first and second upper links, each having upper ends pivotally attached to an upper mounting structure and lower ends pivotally connected to the first ends of first and second lower links, respectively, with the opposite second ends of the lower links pivotally connected together about a rotational axis of an interface configured for connection to a tool set for attachment to the articles for transferring the articles from the receiving location into the container, and an auxiliary linkage arrangement mounted on the actuator and connected to the interface for changing the angle of the interface relative to the horizontal to reduce the profile of the articles as the articles are being placed into the container by the actuator.

In any of the embodiments described herein, wherein the auxiliary linkage arrangement is linked to the actuator, whereby the auxiliary linkage arrangement operates on the interface independent of the motion of the actuator.

In any of the embodiments described herein, wherein the auxiliary linkage arrangement is in the form of a parallelogram comprising a first auxiliary link having a first end pivotally mounted to the upper mounting structure at the same location as the first upper link, a second auxiliary link comprising a link of a first crank arm connected to the interface and pivotally attached to the pivotal connection between the lower end of the first upper link and the first end of the first lower link, a third auxiliary link pivotally interconnected to second end of the first auxiliary link and the second auxiliary link, a fourth auxiliary link comprising the first upper link; and a controller operable on the first auxiliary link to change the angular orientation of the first auxiliary link.

In any of the embodiments described herein, wherein the auxiliary linkage arrangement further comprises a second crank arm connected to the interface and pivotally mounted about the interface axis, and a connector link extending between and pivotally connected to the first and second crank arms, whereby the pivoting motion of the first crank arm is transmitted to the second crank arm to pivot the interface about the horizontal.

In any of the embodiments described herein, wherein the controller comprises a control arm acting on the first auxiliary link to position the first auxiliary link in a selected orientation.

In any of the embodiments described herein, wherein the control arm comprises one (proximal) end pivotally mounted at a fixed location and a second (distal) end connected to the first auxiliary link.

In any of the embodiments described herein, wherein the one end of the control arm is pivotally mounted on the upper mounting structure.

In any of the embodiments described herein, wherein the one end of the control arm is pivotally mounted on the upper mounting structure about the same axis of rotation as the first upper link.

In any of the embodiments described herein, wherein the second end of the control arm is engaged with the first auxiliary link to move along the length of the first auxiliary link.

In any of the embodiments described herein, wherein the second end of the control arm is engaged within a slideway extending along the length of the first auxiliary link.

In any of the embodiments described herein, wherein the second end of the control arm is engaged within a slot extending along the length of the first auxiliary link.

In any of the embodiments described herein, further comprising an actuator to control the rotation of the control arm about the fixed location.

In any of the embodiments described herein, wherein the actuator controlling the rotation of the control arm about a location on the upper mounting structure.

In any of the embodiments described herein, wherein the actuator controlling the rotation of the control arm about the same location on the upper mounting structure as the first upper link.

In any of the embodiments described herein, further comprising a control system to control the operation of the loader system, including the operation of the two axis actuator and the auxiliary linkage arrangement.

In any of the embodiments described herein, wherein the control system controls the operation of the tool set.

In accordance with one embodiment of the present disclosure, a loader system is provided for transferring articles from a receiving location into containers. The loader system includes a five bar linkage arrangement comprising first and second upper links, each having first ends pivotally attached to an overhead mounting support, and second ends pivotally connected to the first ends of first and second lower links, respectively, with the opposite second ends of the lower links pivotally connected about a rotational axis of an interface configured to receive a tool set for the securement of the articles in the transferring of the articles from the receiving location into the container, and an auxiliary linkage arrangement mounted on the actuator and connected to the interface to change the angle of the interface relative to the horizontal, thereby to change the profile of the articles as the articles are being placed into the container by the actuator, the auxiliary linkage arrangement operates on the interface independent of the motion of the actuator.

In any of the embodiments described herein, wherein the auxiliary linkage arrangement is in the form of a parallelogram comprises a first auxiliary link having a first end pivotally mounted to the overhead mounting support at the same location as the first upper link, a second auxiliary link comprising a link of a first crank arm connected to the interface and pivotally attached to the pivotal connection between the lower end of the first upper link and the first end of the first lower link, a third auxiliary link pivotally interconnected to the second end of the first auxiliary link and the second auxiliary link, a fourth auxiliary link comprising the first upper link, and a controller operable on the first auxiliary link to change the angular orientation of the first auxiliary link.

In any of the embodiments described herein, wherein the auxiliary linkage arrangement further includes a second crank arm connected to the interface and pivotally mounted about the interface rotational axis, and a connector link extending between and pivotally connected to the first and second crank arms, whereby the pivoting motion of the first crank arm is transmitted to the second crank arm to pivot the interface about the horizontal.

In any of the embodiments described herein, wherein the controller comprises a control arm acting on the first auxiliary link to change the orientation of the first auxiliary link.

In any of the embodiments described herein, wherein the control arm comprises a proximal end pivotally mounted at a fixed location and a distal end connected to the first auxiliary link.

In any of the embodiments described herein, wherein the proximal end of the control arm is pivotally mounted on the overhead mounting support.

In any of the embodiments described herein, wherein the proximal end of the control arm is pivotally mounted on the overhead mounting support about the same axis of rotation as the first upper link.

In any of the embodiments described herein, wherein the second end of the control arm is engaged with the first auxiliary link to slide along the length of the first auxiliary link.

In any of the embodiments described herein, wherein the second end of the control arm is engaged within a slideway disposed along the length of the first auxiliary link.

In any of the embodiments described herein, wherein the second end of the control arm is engaged within a slot disposed along the length of the first auxiliary link.

In any of the embodiments described herein, further comprising an actuator to control the rotation of the control arm about the fixed location.

In any of the embodiments described herein, wherein the actuator controlling the rotation of the control arm about a location on the upper mounting structure.

In any of the embodiments described herein, wherein the actuator controlling the rotation of the control arm about the same location on the upper mounting structure as the first upper link.

In accordance with another embodiment of the present disclosure, an auxiliary linkage arrangement for a loader system is provided for transferring articles from a receiving location into containers. The loader system includes a two axis actuator comprising first and second upper links, each having upper ends pivotally attached to an upper mounting structure and lower ends pivotally connected to the first ends of first and second lower links, respectively, with the opposite second ends of the lower links pivotally connected together about a rotational axis of an interface configured to receive a tool set for attachment to the articles for transfer from the receiving location into the container through the operation of the actuator, the auxiliary linkage arrangement comprising a first auxiliary link having a first end pivotally mounted to the upper mounting structure at the same location as the first upper link, a second auxiliary link comprising a link of a first crank arm connected to the interface and pivotally attached to the pivotal connection between the lower end of the first upper link and the first end of the first lower link, a second crank arm connected to the interface and pivotally mounted about the interface rotational axis, a connector link extending between and pivotally connected to the first and second crank arms, whereby the pivoting motion of the first crank arm is transmitted to the second crank arm to pivot the interface about the horizontal, a third auxiliary link pivotally interconnected to second end of the first auxiliary link and the second auxiliary link, a fourth auxiliary link comprising the first upper link, the first, second, third, and fourth auxiliary links cooperatively defining a parallelogram, and a controller operable on the first auxiliary link to change the angular orientation of the first auxiliary link and thereby rotating the interface about the interface axis independently of the operation of the actuator.

In any of the embodiments described herein, wherein the controller comprises a control arm acting on the first auxiliary link to position the first auxiliary link in a selected orientation.

In any of the embodiments described herein, wherein the control arm comprises one end pivotally mounted at a fixed location and a second end connected to the first auxiliary link.

In any of the embodiments described herein, wherein the one end of the control arm is pivotally mounted on the upper mounting structure.

In any of the embodiments described herein, wherein the one end of the control arm is pivotally mounted on the upper mounting structure about the same axis of rotation as the first upper link.

In any of the embodiments described herein, wherein the second end of the control arm is engaged with the first auxiliary link to slide along the length of the first auxiliary link.

In any of the embodiments described herein, wherein the second end of the control arm is engaged within a slideway extending along the length of the first auxiliary link.

In any of the embodiments described herein, wherein the second end of the control arm is engaged within a slot extending along the length of the first auxiliary link.

In any of the embodiments described herein, further comprising an actuator to control the rotation of the control arm about the fixed location.

In any of the embodiments described herein, wherein the actuator controls the rotation of the control arm about a location on the upper mounting structure.

In any of the embodiments described herein, wherein the actuator controls the rotation of the control arm about the same location on the upper mounting structure as the first upper link.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial side view of an embodiment of the loader system of the present disclosure;

FIG. 2 is a pictorial side view take from the opposite side of FIG. 1;

FIG. 3 is an end view of FIG. 1 taken from the left side of FIG. 1;

FIG. 4 is a plane view of FIG. 3;

FIGS. 5-9 are side elevational views of FIG. 1 showing the loader system in different positions; and

FIG. 10 is an enlarged fragmentary cross-sectional view of a portion of FIG. 1.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back.” “ahead,” “behind,” “upward,” “downward,” “above,” “below,” “top.” “bottom,” “right hand.” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions or specific references.

The present application may include modifiers such as the words “generally.” “approximately,” “about”, or “substantially.” These terms are meant to serve as modifiers to indicate that the “dimension,” “shape.” “temperature.” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description, various embodiments of the present disclosure are described. In the following description and in the accompanying drawings, the corresponding systems assemblies, apparatus, and units may be identified by the same part number, but with an alpha suffix. The descriptions of the parts/components of such systems assemblies, apparatus, and units that are the same or similar are not repeated so as to avoid redundancy in the present application.

In the present application and claims, references to a “tray.” “carton,” “box.” and “container,” are used interchangeably and are meant to include all manner trays, cartons, boxes and containers to receive articles for packing therein. Also, the present application and claims refer interchangeably to “articles”, “packages” and “items” to be placed or packed into the trays, cartons, boxes, and containers. Further, in the present application the terms “link” and “linkage” are to be considered to be synonymous.

Referring to the FIGURES, a loader system 20 lifts/removes articles 22 from a supply conveyor 24 for placement into containers 26 disposed on a takeaway conveyor 28. The containers 26 have a closure flap 30, or a reinforcing ledge or lip, that extends across the open top of the containers. The loader system 20 includes a 2D actuator 32 for loading the articles 22 received on the supply conveyor 24 into to containers 26. In this regard, when the actuator approaches the containers 26, an auxiliary linkage arrangement 100, operating independently of the actuator, tilts the articles 22, being carried by the actuator, downwardly so the leading edge of the article passes beneath the flap 30, and then rotates the articles into horizontal orientation to set in the containers. A control system 40 controls the operation of the conveyors 24 and 28, as well as the loader system 20, to transfer the articles 22 from the conveyor 24 and into the containers 26.

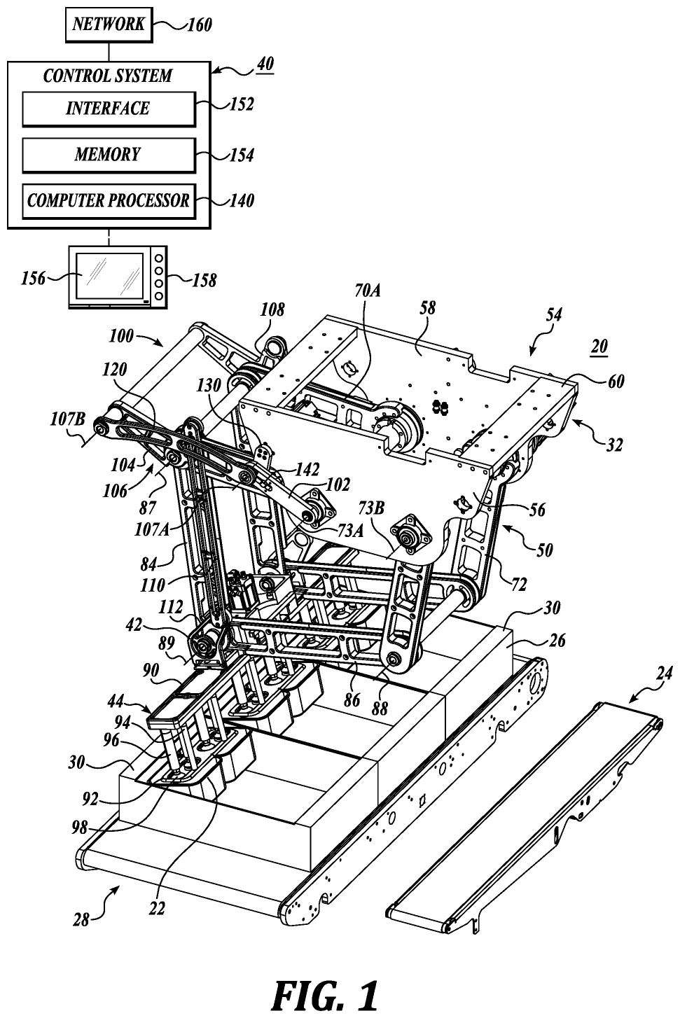

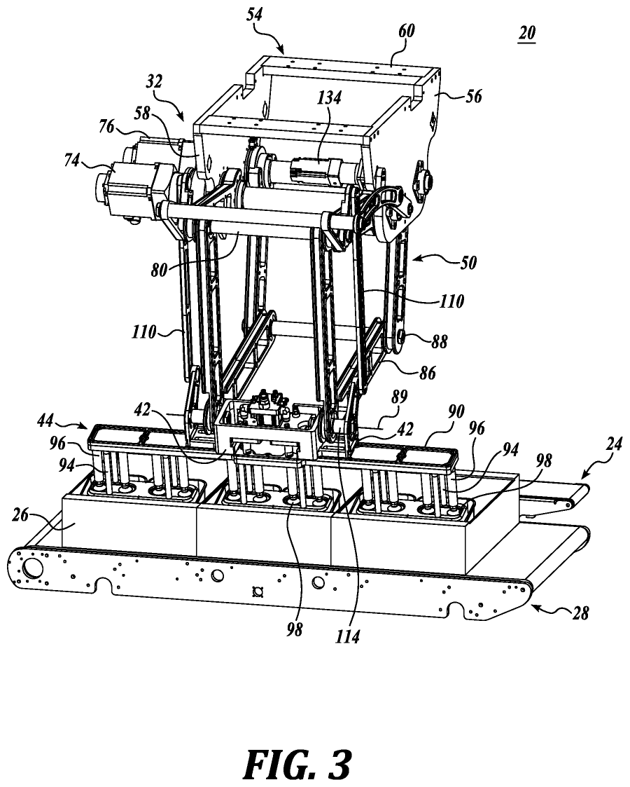

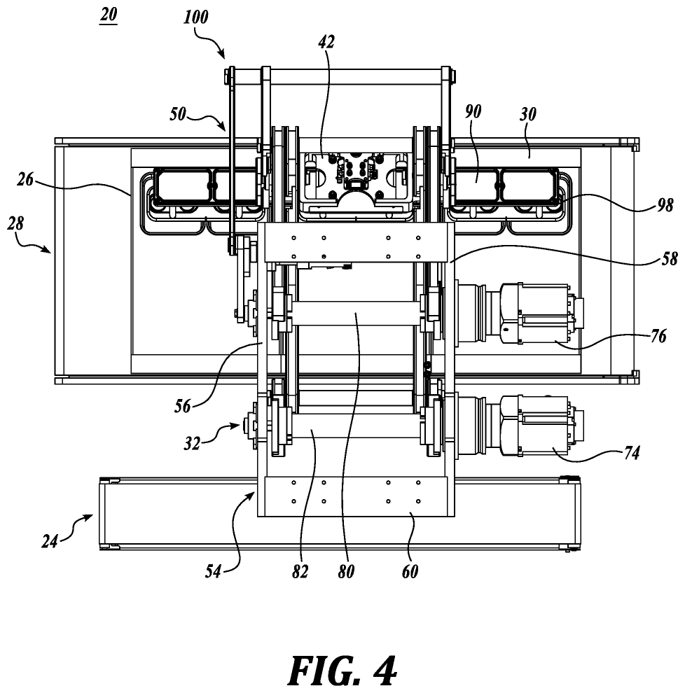

Next describing the components and operation of the loader system 20 in more detail, referring initially to FIGS. 1-4, the loader system includes an interface 42 to which a tool 44 is detachably attached. The tool 44 in turn picks up the articles 22 from the delivery or supply conveyor 24, for placement of the articles in the containers 26. The interface 42 is attached to and moved/manipulated by the actuator 32. The interface can be of an “universal” nature designed to receive different types of tools, with tool 44 being just one example.

The actuator 32 is in the form of a 2D robot 50 which in one embodiment can be a five-bar linkage arrangement. The robot 50 includes an upper or overhead mounting support which is shown as in the form of a frame structure 54. The frame structure 54 includes side plates 56 and 58 that are interconnected by upper crossbars 60 to maintain the side plates in desired spaced parallel relationship to each other.

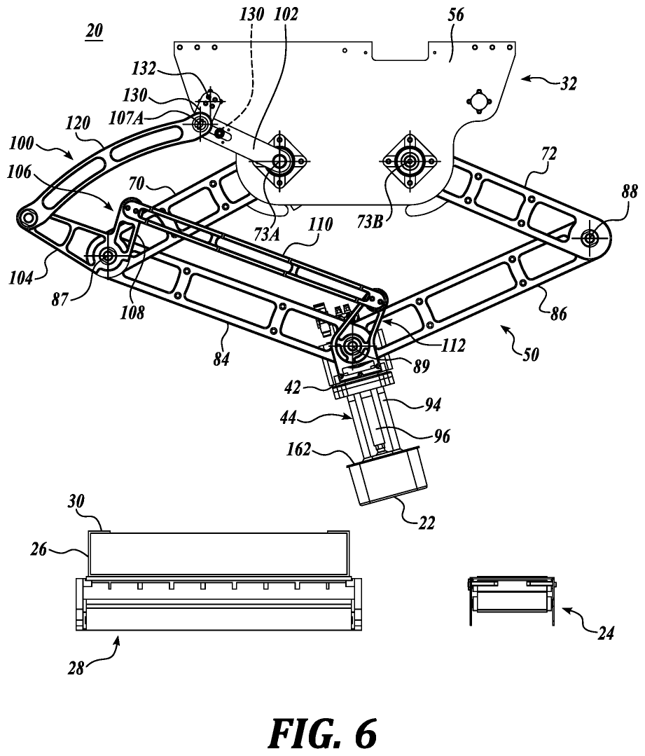

The proximal or upper ends of upper links or linkages 70 and 72 are rotatably mounted to the frame structure 54 at lower portions of the side plates 56 and 58 to pivot about axis 73A and 73B, respectively. Motors or rotational actuators 74 and 76 are mounted on the plate 58 to extend outwardly thereof. The motors 74 and 76 operate to rotate the upper links 70 and 72 through the various operating position of the actuator as shown in FIGS. 6-8 and as described below.

Torque tubes 80 and 82 span between and are attached to the upper links 70 and 72, which are mounted on side plates 56 and 58, so that the upper links located on opposite sides of the actuator 32 rotate together during the operation of motors 74 and 76. The torque tubes 80 and 82 also function to maintain the desired separation between the lower portions of side plates 56 and 58.

The robot 50 of actuator 32 also includes lower links or linkages 84 and 86 extending between the distal ends of upper links 70 and 72 and interface 42. The proximal ends of the lower links or linkages 84 and 86 are pivotally attached to the corresponding links 70 and 72, respectively, to pivot about axis 87 and 88, respectively. The distal ends of the lower links pivot about a common axis 89, about which the interface 42 also pivots.

The transversely extending quick release attachment tool 44 is detachably connected to the interface 42. In one form, the attachment tool 44 includes an upper beam section 90 from which three sets of suction plates 92 depend downwardly via connector columns 94 spanning between the beam section 90 and suction plates 92. Suction tubes 96 also depend downwardly from the beam section 90 to extend through longitudinal slots formed in the suction plates. Suction heads 98 are mounted on the lower ends of the suction tubes 96 to engage the tops of the articles 22 arranged on the supply conveyor 22. The suction tubes 96 are connected to a vacuum source.

It is to be understood that the attachment tool 44 can be of many different configurations, with the above being just one example of an attachment tool configuration. In this regard, although the attachment tool 44 is described is utilizing a vacuum to attach to the tops of the articles 22, other types of attachment tools can be utilized, for example, clamping or gripping units for securing the articles for transfer from the supply conveyor 24 to the containers 26.

As most clearly shown in FIGS. 1 and 5-8, an auxiliary linkage arrangement 100 is provided for maintaining the interface 42, and in particular, the attachment tool 44, together with suction heads 96, in desired orientation while the articles 22 are being transferred from the supply conveyor 24 to the containers 26. During this transfer, as shown in the figures, the articles 22 are tilted to lower the height of their leading ends when being inserted into the containers 26 so as to be low enough to pass beneath a flap 30 extending across the top of the containers.

To this end, the auxiliary linkage arrangement 100 is in the form of a parallelogram interconnected between the frame structure 54, the robot links and the interface 42. In this regard, the auxiliary linkage arrangement 100 includes a first auxiliary link or linkage 102 having an end pivotally mounted to the exterior of side wall 56 of the frame structure 54 at the same location as the proximal ends of the upper links 70, thereby to be pivotal about axis 73A. However, the rotation of the first auxiliary link 102 is independent of the rotation of the upper links 70.

The auxiliary linkage arrangement 100 also includes a second auxiliary link 104 corresponding to link 102. The second auxiliary link 104 is part of an upper crank arm 106 that is pivotally attached to the same location that the distal end of the upper link 70 is attached on the adjacent end of the lower link 84, to also pivot about axis 87. Nonetheless, the rotational movement of the upper crank arm 106 is independent of the rotation of the upper link 70 and the lower link 84. The length of the second auxiliary link 104 is the same as the length of the first auxiliary link 102.

The upper crank arm 106 includes a second arm 108 that extends perpendicular to the second auxiliary link 104 for pivotal connection to the upper end of a transfer link 110. The lower end of the transfer link 110 is pivotally attached to the distal end of a second, lower crank arm 112. The lower crank arm 112 is attached to a shaft 114 to which the interface 42 is also attached. As such, rotation of the lower crank arm 112 about axis 89 results in the corresponding rotation of the interface 42. The distal ends of the lower links 84 and 86 also pivot about the same axis 89.

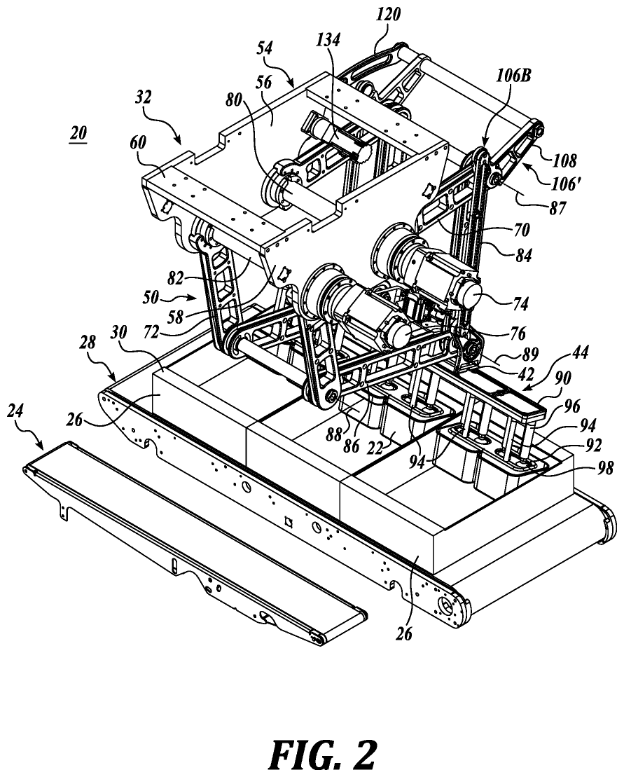

Referring specifically to FIG. 2, a similar crank arm-transfer link arrangement is located on the opposite side of the frame structure 54. However, in this situation the upper crank arm 106′ only has one arm 108 since the auxiliary linkage arrangement is not needed on this side of the frame structure.

The auxiliary linkage arrangement 100 includes a third auxiliary link 120 extending between the distal end of the first auxiliary link 102 and the distal end of the second auxiliary link 104. The ends of the third auxiliary link 120 are pivotally connected to the first auxiliary link 102 to pivot about axis 107A, and is also connected to the second auxiliary link 104 to pivot about axis 107B.

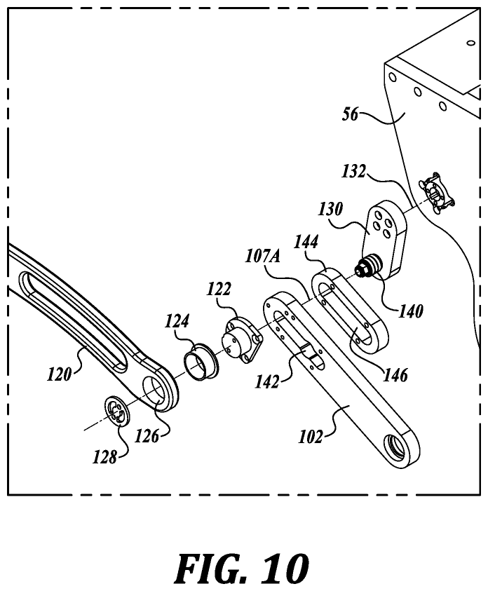

As shown in FIG. 10, the connection between the distal end of the first auxiliary link 102 and the third auxiliary link 120 is achieved through the use of a pivot stub 122 mounted to the distal end of the first auxiliary link 102. A bushing 124 is interposed between the pivot stub 122 and a circular through hole 126 formed in the adjacent end of the auxiliary link 120. An internal lock washer 128 engages over the section of the pivot stub that extends through the hole 126 to retain the auxiliary links 102 and 120 pivotally connected to each other. Of course, other means can be used to retain the auxiliary links 102 and 120 connected together.

The function of the fourth link of the auxiliary linkage arrangement 100 is performed by the upper link 70. The upper link 70 extends between axis 73A and 87. This span is the same as the distance between the rotational axis 107A and 107B.

The configuration or shape of the parallelogram defined by the auxiliary linkage arrangement 100 affects the orientation of the interface 42 relative to the horizontal, and thus the orientation of the tool 44. The orientation of the tool 44 thereby affects the orientation of the articles being loaded into the containers 26.

The shape of the parallelogram defined by the linkage arrangement 100 can be controlled by rotation of a control arm 130 that is pivotally mounted on, and exterior to, the side plate 56. The control arm 130 is powered to rotate about an axis 132 by a rotary actuator 134 extending inwardly from the interior surface of the side plate 56.

As also shown in FIG. 10, roller 140 is rotatably mounted on the distal end of control arm 130 to closely engage and roll within a slot 142 extending or disposed along the distal end of the first auxiliary link 102. An oblong spacer 144 is mounted to the side of the first auxiliary link 102 facing the control arm 130. The spacer is constructed with a slot 146 sized and shaped to match the slot 142.

With this arrangement, the control arm 130 can be rotated as desired to change the angle of the first auxiliary link 102 without affecting the connection between the first auxiliary link and the third auxiliary link. The change of the angle of the first auxiliary link changes the angular relationships between the links of the auxiliary linkage arrangement 100, which in turn, by the rotation of the crank arms 106 and 108, changes the orientation of the interface 42. As a result, the orientation of the articles 22 being moved from the supply conveyor 24 to the containers 26 can be selectively changed independently of the movement of the actuator 32.

It is to be understood that the roller 140 and slot 142 can be replaced with a different connection configuration between the distal end of the control arm 130 and the first auxiliary link. For example, a slideway can be mounted on or built into the first auxiliary link and a pin attached to the distal end of the control arm to move along the slideway.

If desired, the control arm 130 can be rotated into position so that the interface remains horizontal throughout the movement of the actuator 32. This is achieved by rotating the control arm 130 to be parallel with the first auxiliary link 102. The auxiliary linkage arrangement is set up or configured so that when the control arm 130 is parallel with the first auxiliary link 102, the interface 42 is in horizontal orientation. As such, the parallelogram arrangement of the auxiliary linkage will cause the interface to remain in this orientation throughout the movement of the actuator 32.

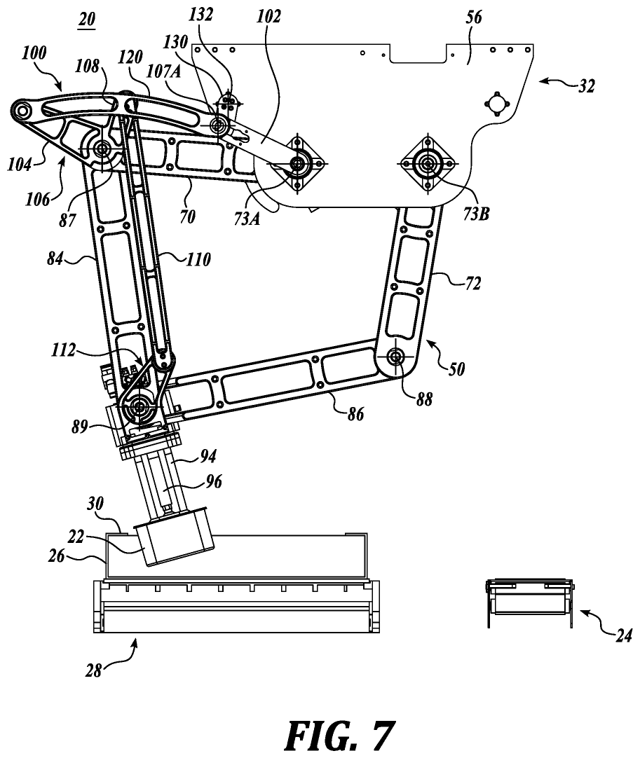

However, as discussed above, the control arm 130 can be rotated relative to the first auxiliary link 102 to change the angle of the first auxiliary link 102 relative to the third 120 and fourth 70 links of the auxiliary linkage arrangement, which in turn causes the crank arms 106 and 108 to rotate, such as shown in FIG. 6, to in turn rotate the interface 42. As a result, the articles being transported are tilted downwardly in the forward direction (in the direction toward the container 26). This tilt of the articles is maintained during further movement of the actuator 32 due to the altered shape of the parallelogram being maintained. See FIG. 7.

The angle of the tilt of the articles can be changed by changing the angle of the control arm 130 relative to the first auxiliary link 102. It may be necessary to tilt the articles more or less to fit under the flap 30 or other obstruction of the container 26. Nonetheless, once the tilt angle of the containers is achieved, that tilt angle remains fixed due to the parallelogram nature of the auxiliary linkage arrangement 100 and not continually changing during movement of the articles from the supply conveyor 24 to the containers 26. This is important if the articles being loaded are fragile, such as certain types of fruits or vegetables or other food items.

As mentioned above, a control system 40 is used to control and operate the loader system 20 of the present disclosure, including the various conveyors 22 and 28 as well as the actuator 32. As shown schematically in FIG. 1, the control system 40 includes a computer or processor 150 which is operably connected to an interface 152 for receiving signals and information from encoders of the various conveyors, as well as data from various sources of loader system 20, including the actuator 32. Correspondingly, the computer/processor 150 sends control signals to the motors that power the conveyors, to the motors 74 and 76 and rotary actuator 134, to the valves that send a vacuum to the attachment tool 44, as well as to other components of the loader system 20. A memory unit 154 is provided for storing information for use by the control system, including the computer/processor 150. A touch screen interface 156 is provided to enable an operator to communicate with the control system 40 and also to output information from the control system, including from the computer/processor 150 about the loader system. The components of the control system 40 can be located in the housing 158 to which the touch screen interface 156 is mounted, or can be at a different location.

The control system 32 can be connected to a network 160. Also, rather than employing a local computer/processor 150, a network computing system can be used for this purpose.

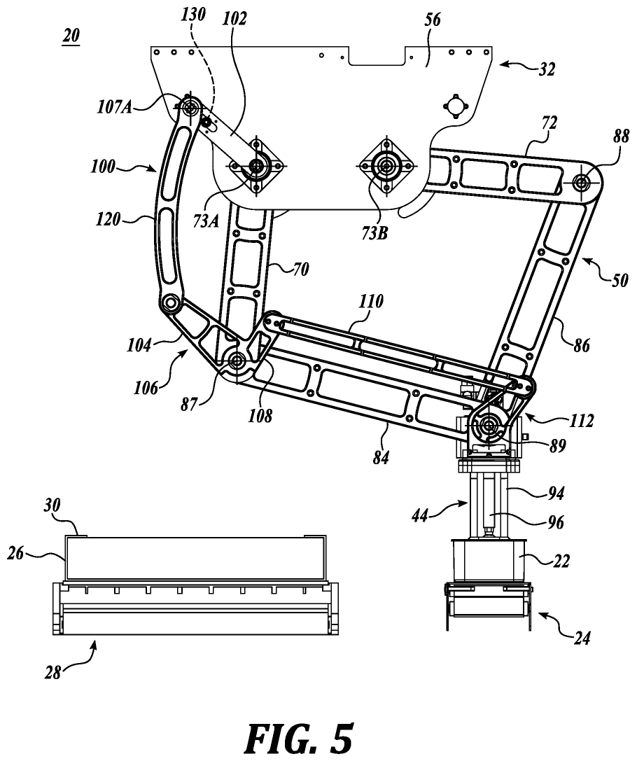

The operation of the loader system 20 is shown in FIGS. 5-8. FIG. 5 shows the positions of the components of the loader system 20 when the tool 44 is positioned over the supply conveyor. The interface 42 is in horizontal orientation and as a result the tool 44 is also horizontally disposed so that suction plates 92 of the tool lies flat on the top of the articles 22 to enable the suction heads 98 to bear against and grasp the articles.

As shown in FIG. 5, the control arm 130 is parallel to the length of the first auxiliary link arm 102. The actuator 32 and auxiliary linkage arrangement 100 are “set up” so that when the control arm 130 is parallel to the length of the first auxiliary link arm 102, the interface 42 is in horizontal orientation.

FIG. 6 shows the positions of the components of the loader system 20 when the articles 22 have been transported part of the way to the containers 26. The control arm 130 has been actuated to rotate the first auxiliary link arm 102 relative to the third auxiliary link arm, causing a corresponding rotation of the first or upper crank arm 106. As a result, the interface 42 has been rotated in the counterclockwise direction, thereby to tilt the articles to a desired angle, thereby reducing the profile of the articles 22. The parallelogram shape of the auxiliary linkage arrangement is maintained as the articles continue toward the containers 25 so that the same angle of tilt of the articles 22 is maintained. See FIGS. 6 and 7.

FIG. 7 shows the tilted articles 22 passing under an obstacle in the form of the lip or flap 30 of the container 26. The articles are sufficiently tilted so the leading upper edge 162 of the containers are lowered enough to pass beneath the lip/flat 30. Because of the parallelogram nature of the auxiliary linkage arrangement 100, the angle of tilt of the articles 22, caused by the rotation of the control arm 130, is maintained during the range of movement of the 2D actuator 32, including while being placed into the container 26 at an angle to pass beneath the lip/flap.

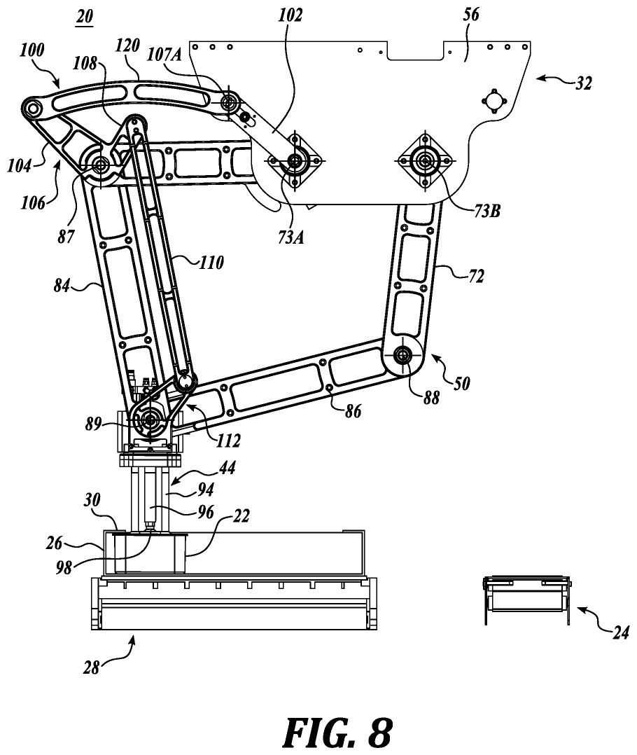

FIG. 8 shows the articles 22 lying flat within the container 26 beneath the lip/flap 30. This orientation of the articles is achieved by operating the control arm 130 to rotate into a position in line with the first auxiliary link 102. The control system causes the tool 44 to release the articles 22 so that the tool can travel back to the supply conveyor 24 to collect the next set of products.

It will be appreciated that the loader system 20 of the present disclosure enables articles to be placed into container even though an obstacle is present that does not allow the articles in be simply lowered vertically into the container. Further this is accomplished without adding a significant amount of moving mass to the loader system. The links of the auxiliary linkage arrangement add only a nominal amount of weight to the 2D actuator. As such, it is feasible to retrofit existing 2D actuators with an auxiliary linkage arrangement that is the same as or similar to that of arrangement 100.

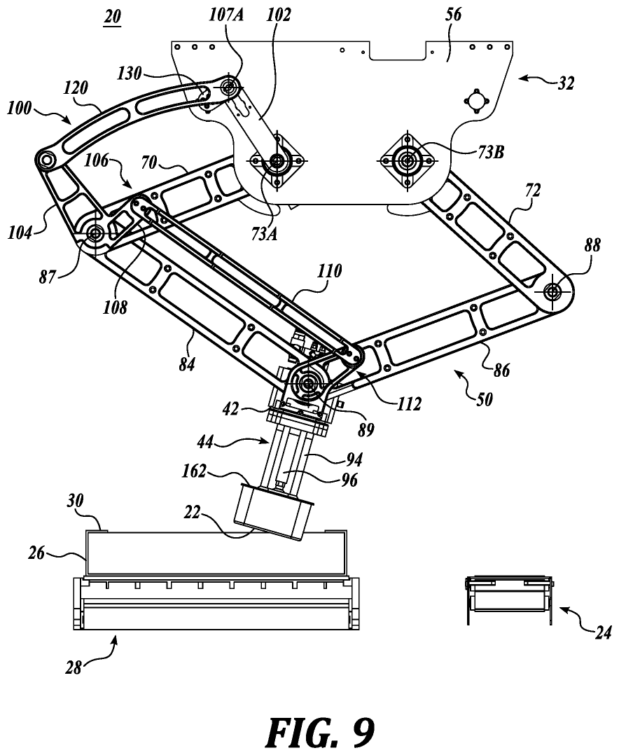

FIG. 9 corresponds to FIG. 7, but showing the loader system tilting the articles 22 for passing under an obstacle in the form of the lip or flap 30 of the container 26 at the opposite end of the container than shown in FIG. 7. The articles are sufficiently tilted so the leading upper edge of the containers are lowered enough to pass beneath the lip/flat 30. The control arm 130 is positioned 180 degrees from its position in FIG. 7. However, as in FIG. 7, because of the parallelogram nature of the auxiliary linkage arrangement 100, the angle of tilt of the articles 22, caused by the rotation of the control arm 130, is maintained during the range of movement of the 2D actuator 32, including while being placed into the container 26 at an angle to pass beneath the lip/flap 30.

While illustrative embodiments have been illustrated and described, it will be appreciated that various changes can be made therein without departing from the spirit and scope of the invention.

1. A loader system for transferring articles from a receiving location into containers that may have an obstruction extend at least a part of the opening of the container (closing a portion of the container open top), the loader system comprising:
a two axis actuator comprising first and second upper links, each having upper ends pivotally attached to an upper mounting structure and lower ends pivotally connected to the first ends of first and second lower links, respectively, with the opposite second ends of the lower links pivotally connected together about a rotational axis of an interface configured for connection to a tool set for attachment to the articles for transferring the articles from the receiving location into the container; and
an auxiliary linkage arrangement mounted on the actuator and connected to the interface for changing the angle of the interface relative to the horizontal to reduce the profile of the articles as the articles are being placed into the container by the actuator.

2. The loader system of claim 1, wherein the auxiliary linkage arrangement is linked to the actuator, whereby the auxiliary linkage arrangement operates on the interface independent of the motion of the actuator.

3. The loader system of claim 2, wherein the auxiliary linkage arrangement is in the form of a parallelogram comprising:
a first auxiliary link having a first end pivotally mounted to the upper mounting structure at the same location as the first upper link;
a second auxiliary link comprising a link of a first crank arm connected to the interface and pivotally attached to the pivotal connection between the lower end of the first upper link and the first end of the first lower link;
a third auxiliary link pivotally interconnected to second end of the first auxiliary link and the second auxiliary link;
a fourth auxiliary link comprising the first upper link; and
a controller operable on the first auxiliary link to change the angular orientation of the first auxiliary link.

4. The loader system of claim 3, wherein the auxiliary linkage arrangement further comprising:
a second crank arm connected to the interface and pivotally mounted about the interface axis; and
a connector link extending between and pivotally connected to the first and second crank arms, whereby the pivoting motion of the first crank arm is transmitted to the second crank arm to pivot the interface about the horizontal.

5. The loader system of claim 3, wherein the controller comprising a control arm acting on the first auxiliary link to position the first auxiliary link in a selected orientation.

6. The loader system of claim 5, wherein the control arm comprising one (proximal) end pivotally mounted at a fixed location and a second (distal) end connected to the first auxiliary link.

7. The loader system of claim 6, wherein the one end of the control arm is pivotally mounted on the upper mounting structure.

8. The loader system of claim 7, wherein the one end of the control arm is pivotally mounted on the upper mounting structure about the same axis of rotation as the first upper link.

9. The loader system of claim 5, wherein the second end of the control arm is engaged with the first auxiliary link to move along the length of the first auxiliary link.

10-11. (canceled)

12. The loader system of claim 6, further comprising an actuator to control the rotation of the control arm about the fixed location.

13. The loader system of claim 12, wherein the actuator controlling the rotation of the control arm about a location on the upper mounting structure.

14. The loader system of claim 13, wherein the actuator controlling the rotation of the control arm about the same location on the upper mounting structure as the first upper link.

15. The loader system of claim 1, further comprising a control system to control the operation of the loader system, including the operation of the two axis actuator and the auxiliary linkage arrangement.

16. The loader system of claim 15, wherein the control system controls the operation of the tool set.

17-19. (canceled)

30. An auxiliary linkage arrangement for a loader system for transferring articles from a receiving location into containers, the loader system comprising a two axis actuator comprising first and second upper links, each having upper ends pivotally attached to an upper mounting structure and lower ends pivotally connected to the first ends of first and second lower links, respectively, with the opposite second ends of the lower links pivotally connected together about a rotational axis of an interface configured to receive a tool set for attachment to the articles for transfer from the receiving location into the container through the operation of the actuator, the auxiliary linkage arrangement comprising:
a first auxiliary link having a first end pivotally mounted to the upper mounting structure at the same location as the first upper link;
a second auxiliary link comprising a link of a first crank arm connected to the interface and pivotally attached to the pivotal connection between the lower end of the first upper link and the first end of the first lower link;
a second crank arm connected to the interface and pivotally mounted about the interface rotational axis;
a connector link extending between and pivotally connected to the first and second crank arms, whereby the pivoting motion of the first crank arm is transmitted to the second crank arm to pivot the interface about the horizontal;
a third auxiliary link pivotally interconnected to second end of the first auxiliary link and the second auxiliary link;
a fourth auxiliary link comprising the first upper link;
the first, second, third, and fourth auxiliary links cooperatively defining a parallelogram; and
a controller operable on the first auxiliary link to change the angular orientation of the first auxiliary link and thereby rotating the interface about the interface axis independently of the operation of the actuator.

31. The loader system of claim 30, wherein the controller comprising a control arm acting on the first auxiliary link to position the first auxiliary link in a selected orientation.

32. The loader system of claim 31, wherein the control arm comprising one end pivotally mounted at a fixed location and a second end connected to the first auxiliary link.

33. The loader system of claim 32, wherein the one end of the control arm is pivotally mounted on the upper mounting structure.

34. The loader system of claim 33, wherein the one end of the control arm is pivotally mounted on the upper mounting structure about the same axis of rotation as the first upper link.

35. The loader system of claim 31, wherein the second end of the control arm is engaged with the first auxiliary link to slide along the length of the first auxiliary link.

36-37. (canceled)

38. The loader system of claim 32, further comprising an actuator to control the rotation of the control arm about the fixed location.

39-40. (canceled)
